(19) United States
(12) Patent Application Publication
(10) Pub. No.: US 2021/0102688 A1
(43) Pub. Date: Apr. 8, 2021

(54) VERSATILE UTILITY LIGHT

(71) Applicant: TipSee Light Co., LLC, Rochester, NY (US)

(72) Inventor: Steve LaBUZETTA, Rochester, NY (US)

(73) Assignee: TipSee Light Co., LLC, Rochester, NY (US)

(21) Appl. No.: 17/064,727

(22) Filed: Oct. 7, 2020

Related U.S. Application Data
(60) Provisional application No. 62/911,910, filed on Oct. 7, 2019.

(51) Int. Cl. F21V 21/088; F21V 21/096; F21V 21/32; F21V 23/04

(52) U.S. Cl. CPC F21V 21/0885; F21V 23/0421; F21V 21/32; F21V 21/0965

(57) ABSTRACT

A light comprising a housing comprised of an elongated body having a forward end and a rearward end and defining a longitudinal axis, a first bracket arm and a second bracket arm extending outwardly from the elongated body, and a light source contained in the forward end of the elongated body and operable to emanate light outwardly from the housing. The first bracket arm is comprised of an inner wall opposed to an inner wall of the second bracket arm. The opposed inner walls of the first and second bracket arms define a first open ended cavity capable of receiving a first mounting object. The opposed inner walls of the first and second bracket arms may be comprised of arcuate surfaces defining the first open ended cavity as a cylindrical cavity. The first bracket arm and the second bracket arm may be flexible arms joined to the elongated body.

### CROSS-REFERENCE TO RELATED PATENT APPLICATIONS

This application claims the benefit of U.S. Provisional Patent Application No. 62/911,910 filed Oct. 7, 2019, the disclosure of which is incorporated herein by reference. The above benefit claim is being made in an Application Data Sheet submitted herewith in accordance with 37 C.F.R. 1.76 (b)(5) and 37 C.F.R. 1.78.

### TECHNICAL FIELD

Compact self-contained utility lights mountable upon a variety of objects.

### BACKGROUND

Bright lighting is essential in accomplishing many tasks in a safe and efficient manner. There is a need for a compact utility light that can be used in providing lighting to perform a variety of tasks in a “hands free” manner with respect to the light. There is also a need that such a utility light is versatile in that it can be removably mounted on a variety of objects so that it can be mounted on a particular object proximate to or related to the task, provide the light needed by the performer of the task, and then removed, and reused for lighting subsequent tasks.

### SUMMARY

Utility lights of the present disclosure meet this need for versatile lighting. In one aspect of the present disclosure, a utility light is provided comprising a housing comprised of an elongated body having a forward end and a rearward end and defining a longitudinal axis, a first bracket arm and a second bracket arm extending outwardly from the elongated body, and a light source contained in the forward end of the elongated body and operable to emanate light outwardly from the housing. The first bracket arm is comprised of an inner wall opposed to an inner wall of the second bracket arm. The opposed inner walls of the first and second bracket arms define a first open ended cavity capable of receiving a first mounting object. The opposed inner walls of the first and second bracket arms may be comprised of arcuate surfaces defining the first open ended cavity as a cylindrical cavity. The first bracket arm and the second bracket arm may be flexible arms joined to the elongated body.

In some cases, the first bracket arm may be comprised of a first elongated forward member extending substantially parallel to the longitudinal axis of the elongated body, and the second bracket arm may be comprised of a second elongated forward member extending substantially parallel to the longitudinal axis of the elongated body. Each of the first and second forward members may include a recess. The recesses of the first and second forward members and the elongated body define a second open ended cavity capable of receiving a second mounting object. The recesses of the first and second forward members may be comprised of arcuate surfaces defining the second open ended cavity as a cylindrical cavity. The first bracket arm may be further comprised of a first elongated rearward member including a first barb, and the second bracket arm may be further comprised of a second elongated rearward member including a second barb. The first and second barbs and the elongated body define a third open ended cavity for receiving a third mounting object.

In some cases, the light may be further comprised of an elastic pad joined to the elongated body of the housing and extending longitudinally between the first and second bracket arms. In some cases, the light may be further comprised of an elastic pad joined to the elongated body of the housing and contiguous with the second open ended cavity. The elongated body, the first bracket arm, and the second bracket arm may be made of a single piece of material. The light may be further comprised of a switch disposed in the rearward end of the elongated body of the housing, a membrane capable of actuating the switch, and a magnet disposed between the switch and the membrane.

### BRIEF DESCRIPTION OF THE DRAWINGS

The present disclosure will be provided with reference to the following drawings, in which like numerals refer to like elements, and in which:

FIG. 1 is an upper rearward perspective view of a light of the present disclosure;

FIG. 2 is a upper forward perspective view of the light of FIG. 1;

FIG. 3 is a side cross-sectional view of the light of FIG. 1, taken along lines 3-3 of FIG. 2;

FIG. 4 is a side elevation view of the light of FIG. 1;

FIG. 5 is a forward elevation view of the light of FIG. 1, taken along line 5-5 of FIG. 4;

FIG. 6 is a rearward elevation view of the light of FIG. 1, taken along line 6-6 of FIG. 4;

FIG. 7 is a side elevation view of the light as shown in FIG. 4, engaged with a first mounting object in an axial orientation;

FIG. 8 is a forward elevation view of the light as shown in FIG. 5, engaged with the first mounting object shown in FIG. 7, taken along line 8-8 of FIG. 7;

FIG. 9 is a side elevation view of the light as shown in FIG. 4, engaged with a second mounting object in a transverse orientation;

FIG. 10 is a forward elevation view of the light as shown in FIG. 5, engaged with the second mounting object shown in FIG. 9, taken along line 10-10 of FIG. 9;

FIG. 11 is a forward elevation view of a light of the present disclosure, further comprising an elastic pad joined to the elongated body of the housing and extending longitudinally between the first and second bracket arms;

FIG. 12 is a forward elevation view of the light of FIG. 11, mounted axially on a third object;

FIG. 13 is a side elevation view of the light of FIG. 11 and third object, taken along line 13-13 of FIG. 12;

FIG. 14 is a side elevation view of the light of FIG. 11 mounted transversely on the third object; and

FIGS. 15-22 are illustrations of the light of the present disclosure removably joined to various objects, thereby showing the versatility of the light in exemplary uses thereof.

The present invention will be described in connection with certain embodiments. However, it is to be understood that there is no intent to limit the invention to the embodiments described. On the contrary, the intent is to cover all alternatives, modifications, and equivalents as may be included within the spirit and scope of the invention as defined by the appended claims.

### DETAILED DESCRIPTION

For a general understanding of the present invention, reference is made to the drawings. In the drawings, like reference numerals have been used throughout to designate identical elements. The drawings are to be considered exemplary, and are for purposes of illustration only. The dimensions, positions, order and relative sizes reflected in the drawings attached hereto may vary.

In the following disclosure, the housing and bracket arms are described in combination with a light source, in the context of use as a light. However, the present disclosure is not to be construed as being limiting the housing and bracket arms only to use with a light source. The housing and bracket arms are adaptable to any use in which mounting of a device comprised of the housing and bracket arms on an object is desirable to be provided. Additionally, the description may identify certain components of the light of the present disclosure with the adjectives “top,” “upper,” “bottom,” “lower,” “left,” “right,” “forward,” “rearward,” etc. These adjectives are provided in the context of the orientation of the drawings, which is arbitrary. The description is not to be construed as limiting the light of the present disclosure to use in a particular spatial orientation. The instant light may be used in orientations other than those shown and described herein.

It is also to be understood that any connection references used herein (e.g., attached, coupled, connected, and joined) are to be construed broadly and may include intermediate members between a collection of elements and relative movement between elements unless otherwise indicated. As such, connection references do not necessarily imply that two elements are directly connected and in fixed relation to each other.

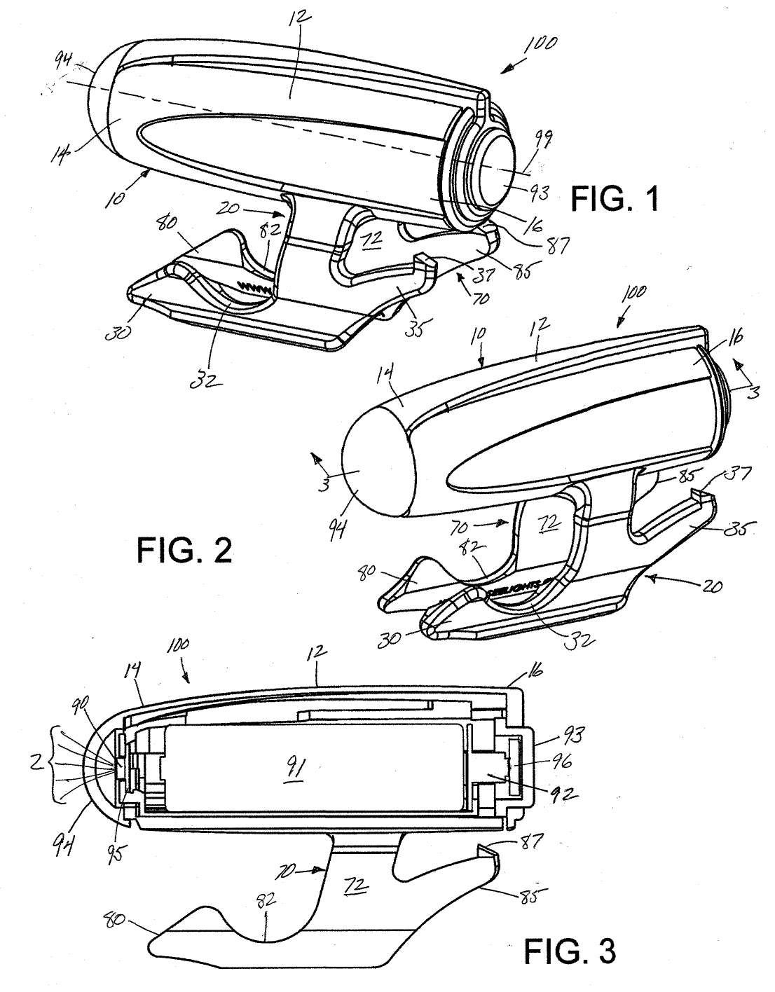

Turning now to FIGS. 1-6, an exemplary light of the present disclosure will be described. The light 100 is comprised of a housing 10 comprised of an elongated body 12 having a longitudinal axis 99, a forward end 14, a rearward end 16, a first bracket arm 20 and a second bracket arm 70 extending outwardly from the elongated body 10, and a light source 90 contained in the forward end 14 of the elongated body 12 and operable to emanate light 2 outwardly from the housing 10. Referring in particular to the cross-sectional view shown in FIG. 3, the light 100 may be further comprised of a battery 91 to supply electrical power, an on/off switch 92, a push button diaphragm or membrane 93 for operation of the switch 92, and a lens 94 for transmitting and directing the light 2 from the light source 90. The light source 90 may be a light emitting diode mounted upon a small circuit board 95. Electrical conductors, such as wires or metal strips (not shown) are provided to complete the electrical circuit from the battery 91 through the switch 92, the light source 90, and back to the battery ground terminal. It is to be understood that the arrangement of the electrical circuit, battery 91, and light source 92 within the housing 10 are to be considered exemplary and not limiting. Other arrangements are contemplated which will achieve the same result of energizing the light source 90 and emanating light 2.

In some cases, the push button membrane may be made of a flexible material, such as an elastomer or rubber, which may enable the membrane to actuate the switch, and then spring back into a neutral position when a user's finger or thumb removes pressure on the membrane. Referring to FIG. 3 in particular, in some cases, the light may be provided with a magnet 96 between the switch 92 and the membrane 93. In that manner, when the membrane 93 is depressed, the magnet is displaced and operates the on-off action of the switch. Additionally, the magnet 96 is made of a magnetic material with sufficient magnetic strength so as to provide another way of temporarily attaching the light 10 to a mounting object made of a ferromagnetic material such as steel. Without limitation, a suitable magnet may be made of neodymium. The membrane 93 of the light 10 is contacted with the ferromagnetic material, and by the strong attraction of the magnet 96 through the membrane to the ferromagnetic material, the light 10 is held in a desired position until the user removes it.

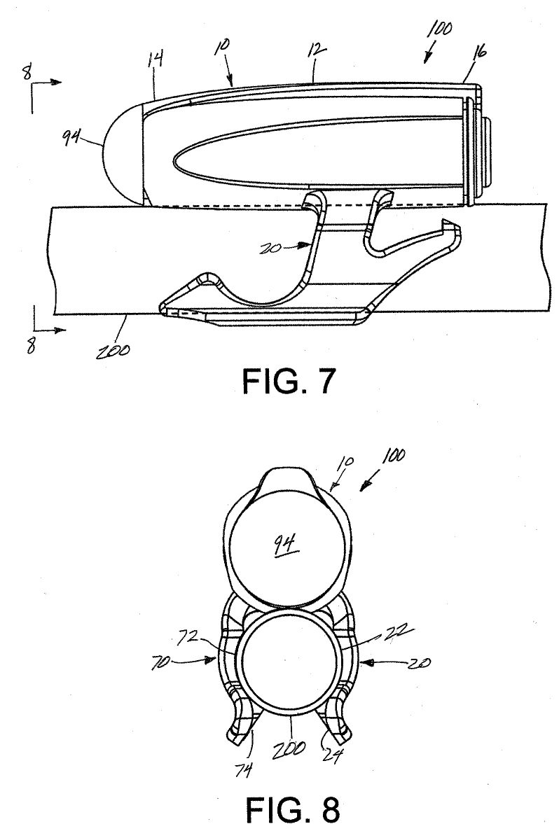

The first bracket arm 20 is comprised of an inner wall 22 opposed to an inner wall 72 of the second bracket arm 70. Referring also to FIGS. 7 and 8, the opposed inner walls 22 and 72 of the respective first and second bracket arms 20 and 70 define a first open ended cavity 4 for receiving a first mounting object 200. The opposed inner walls 22 and 72 of the first and second bracket arms 20 and 70 may be comprised of arcuate surfaces, thereby defining the first open ended cavity 4 as a cylindrical cavity. Such arcuate surfaces are effective when the first mounting object 200 is a cylindrical tube or rod.

The first bracket arm 20 and the second bracket arm 70 may be flexible arms 20 and 70 joined to the elongated body. Such flexibility may enable mounting objects to be received in an interference fit in the first open ended cavity 4. Referring to FIGS. 5 and 6, when the light 100 and first mounting object 200 are moved toward each other as indicated by arrow 98, when the first mounting object 200 contacts the angled foot surfaces 24 and 74, these surfaces 24 and 74 provide a camming action, such that the arms 20 and 70 flex outwardly as indicated by arrows 97. The amount of flexure is sufficient to allow the first mounting object 200 to pass through the gap between the arms 20 and 70, and be seated in the open ended cavity 4. Upon such seating, the flexible arms 20 and 70 snap back into the position shown in FIG. 8. If the diameter of the first mounting object 200 is greater than the diameter of (or distance across) the first open ended cavity 4 in its empty state (FIGS. 5 and 6), then the flexible arms 20 and 70 apply an inward force upon the first mounting object 200, thereby holding the light 100 in place on the first mounting object 200 by an interference fit.

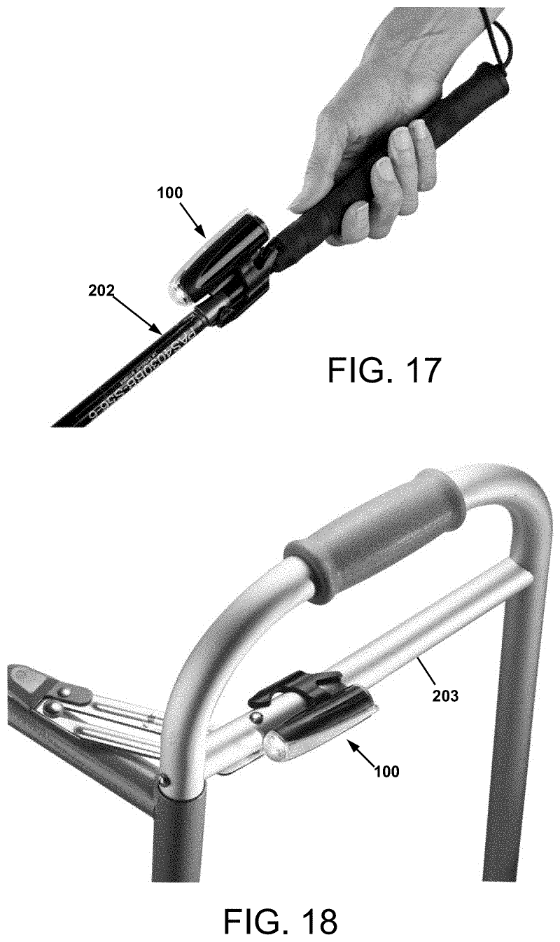

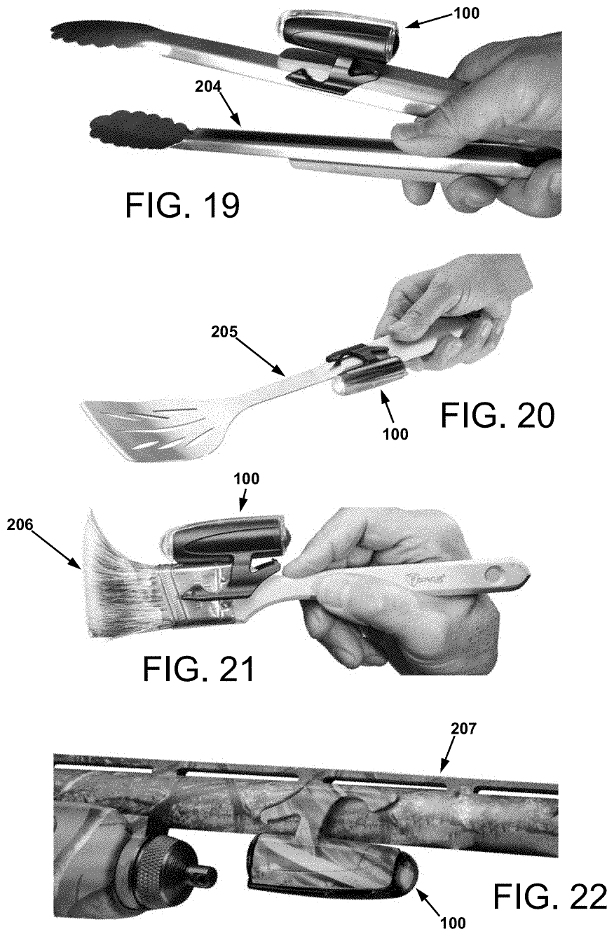

In FIGS. 7 and 8, the light 100 is mounted on the first mounting object 200 in an axial orientation, i.e., the longitudinal axis of the housing 10 of the light 100 is substantially parallel with a longitudinal axis of the first mounting object 100. Practical examples of such axial mounting arrangements are further depicted as follows: FIG. 16, mounting of the light 100 on the shaft of a walking cane 201 to light the floor area beneath the cane 201; FIG. 17, mounting of the light 100 on the shaft of a walking stick 202, to light the area where the stick 202 is directed; FIG. 18, mounting of the light 100 on a strut 203 of a walker, to light the area in front of the walker; FIG. 19, mounting of the light 100 on tongs 204, to light the area for gripping by the tongs 204; FIG. 20, mounting of the light 100 on a spatula 205, to light the area for moving food with the spatula 205; FIG. 21, mounting of the light 100 on a paint brush 206, to light the area being painted; and FIG. 22, mounting of the light 100 on a firearm 207, to light the area at which the firearm 207 is directed. It can be seen from the applications shown in FIGS. 19-21 that it is not necessary that the mounting object be cylindrical in shape. The mounting object may have any shape that can be engaged within the open ended cavity 4 of the light 100.

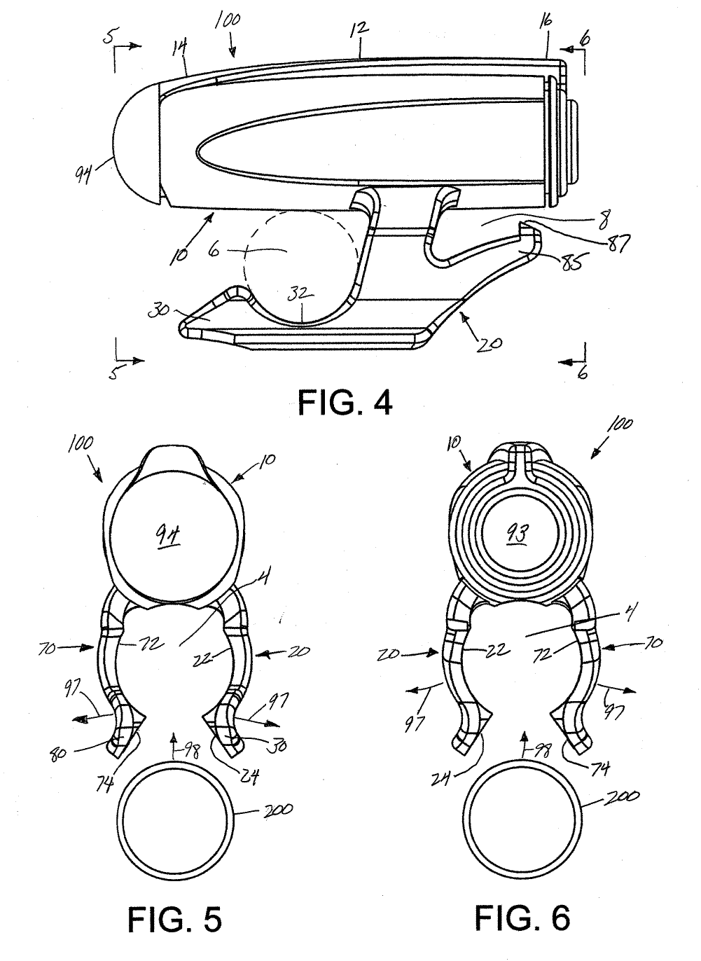

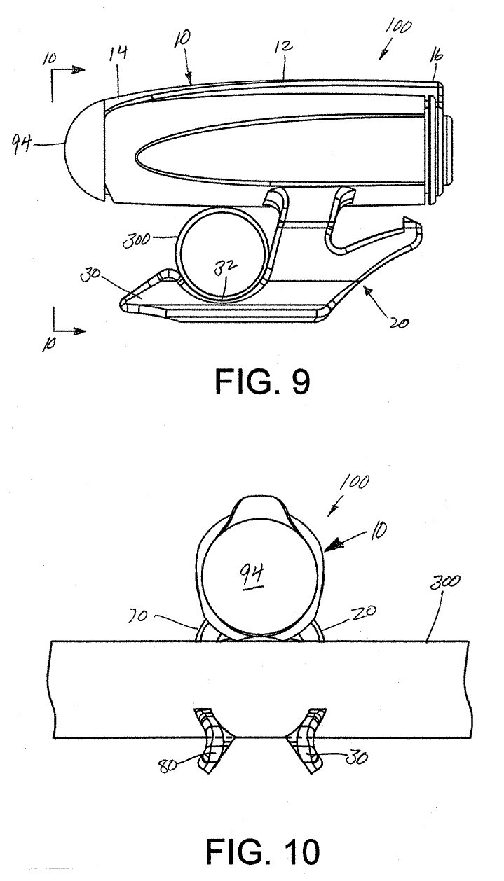

Referring again to FIGS. 1-4, in certain cases, the first bracket arm 20 may be comprised of a first elongated forward member 30 extending substantially parallel to the longitudinal axis 99 of the elongated body 10, and the second bracket arm 70 may be comprised of a second elongated forward member 80 extending substantially parallel to the longitudinal 99 axis of the elongated body. The first forward member 30 includes a recess 32, and the second forward member 80 includes a recess 82. Referring also to FIGS. 9 and 10, the respective recesses 32 and 82 of the first and second forward members 30 and 80 and the elongated body 10 define a second open ended cavity 6 for receiving a second mounting object 300. The recesses 32 and 82 of the first and second forward members 30 and 80 may be comprised of arcuate surfaces defining the second open ended cavity 6 as a cylindrical cavity. The first and second forward members 30 and 80 may be flexible members, so as to enable the second mounting object 300 to be snap fitted into the second open ended cavity 6, in a manner similar to that described for fitting the first mounting object 200 into the first open ended cavity 4. If the diameter of the second mounting object 300 is greater than the diameter of (or distance across) the second open ended cavity 6 in its empty state (FIG. 4), then the first and second forward members 30 and 80 and elongated body 10 coact to apply an inward force upon the second mounting object 300, thereby holding the light 100 in place on the second mounting object 300 by an interference fit.

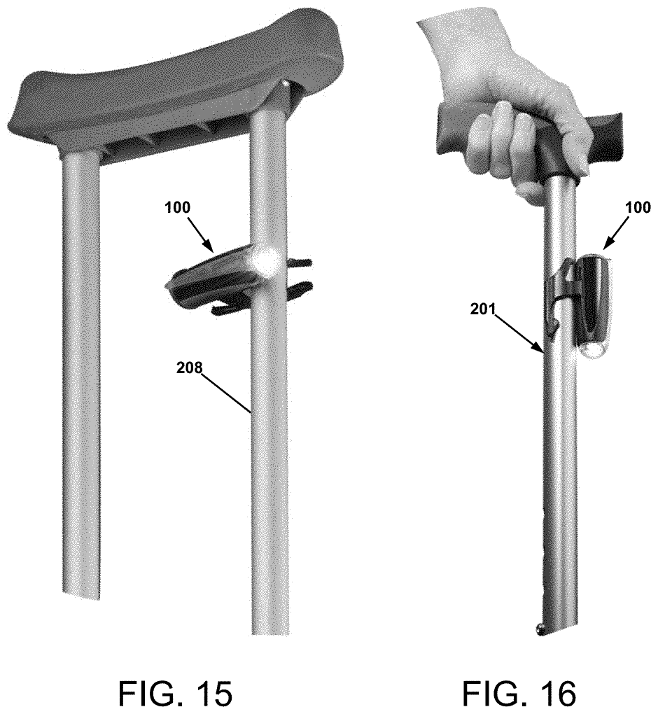

In FIGS. 9 and 10, the light 100 is mounted on the second mounting object 300 in a transverse orientation, i.e., the longitudinal axis of the housing 10 of the light 100 is substantially perpendicular to a longitudinal axis of the second mounting object 300. A practical example of such transverse mounting is further depicted in FIG. 15, wherein mounting of the light 100 on the strut 208 of a crutch is done to light the area in front of the user of the crutch.

Referring again to FIGS. 1-4, the first bracket arm 20 may be further comprised of a first elongated rearward member 35 including a first barb 37, and the second bracket arm 70 may be further comprised of a second elongated rearward member 85 including a second barb 87. The first and second barbs 37 and 87 and the elongated bodyl0 define a third open ended cavity 8 for receiving a third mounting object (not shown). One exemplary third mounting object is a baseball cap, wherein the bill of the cap is inserted into the third open ended cavity 8. With the bill of the cap being of compliant material, the barbs engage with the bill, thereby holding the light securely on the cap, with the light 2 directed forwardly to light the area in front of the wearer of the cap. It will be apparent that the light 100 can be removably joined to a variety of other wafer-like objects in this manner.

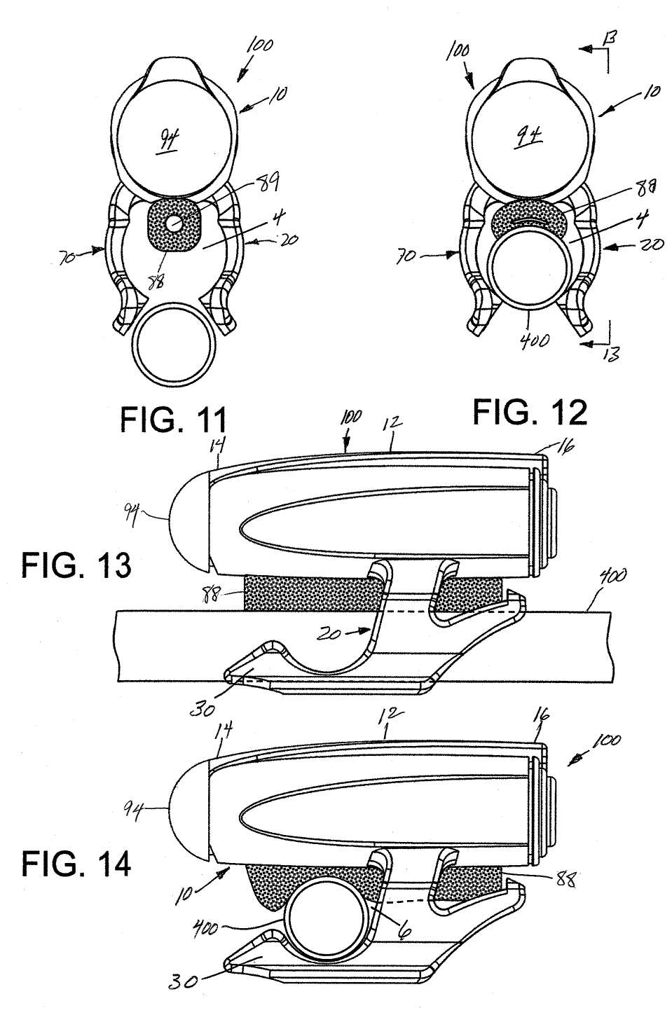

Referring to FIG. 11, in some cases, the light 100 may be further comprised of an elastic pad 88 joined to the elongated body 12 of the housing 10 and extending longitudinally between the first and second bracket arms 20 and 70. This feature may be advantageous when it is desirable to mount the light 100 on an object that has a diameter or cross-sectional size that is smaller than the diameter of the first open ended cavity 4 or the second open ended cavity 6. In such circumstances, the light 100 would have a loose fit by engagement at open ended cavity 4 or cavity 6 on the mounting object and not be secure. In use with the object, the light 100 would move relative to the object, and thus not direct the light to the desired location.

In some cases, the elastic pad 88 may be made of closed cell rubber or polymer foam. In one exemplary light 100, a piece of gasket material was used as an elastic pad 88. The material was extruded foam rubber and included a central passageway 89 and a strip of adhesive joining to the housing 10 of the mounting object.

FIGS. 12 and 13 depict an application wherein a mounting object 400 is removably joined to the light 100 in an axial orientation. It can be seen that the elastic pad 88 has deformed substantially where it is in contact with the object 400. Thus, despite the diameter of the object 400 being considerably smaller than the diameter of the cavity 4, the mounting object 400 is firmly joined to the light 100. FIG. 14 depicts an application wherein a mounting object 400 is removably joined to the light 100 in a transverse orientation. In like manner, it can be seen that the elastic pad 88 has deformed substantially where it is in contact with the object 400, and that the mounting object 400 is firmly joined to the light 100.

In some cases, the elongated body 10, the first bracket arm 20, and the second bracket arm 70 of the light 100 may be made of a single piece of material. The pieces 10, 20, and 70 may be made in a single piece by molding, or by a subtractive process such as CNC milling, or by an additive process such as fused deposition modelling (FDM), also known as 3D printing. Suitable piece materials include, but are not limited to, plastics and metals. In one case, the housing of the light may be made of polycarbonate plastic.

It is therefore apparent that there has been provided, in accordance with the present disclosure, a utility light. The foregoing description of technology and the invention is merely exemplary in nature of the subject matter, manufacture, and use of the invention and is not intended to limit the scope, application, or uses of any specific invention claimed in this application or in such other applications as may be filed claiming priority to this application, or patents issuing therefrom. The following definitions and non-limiting guidelines must be considered in reviewing the description.

The headings in this disclosure (such as “Background” and “Summary”) and sub-headings used herein are intended only for general organization of topics within the present technology, and are not intended to limit the disclosure of the present technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The description and specific examples, while indicating embodiments of the technology disclosed herein, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

To the extent employed herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

Unless otherwise specified, relational terms used in the present disclosure should be construed to include certain tolerances that those skilled in the art would recognize as providing equivalent functionality. By way of example, the term perpendicular is not necessarily limited to 90.00° , but also to any variation thereof that those skilled in the art would recognize as providing equivalent functionality for the purposes described for the relevant member or element. Terms such as “about” and “substantially” in the context of configuration relate generally to disposition, location, and/or configuration that is either exact or sufficiently close to the location, disposition, or configuration of the relevant element to preserve operability of the element within the invention while not materially modifying the invention. Similarly, unless specifically specified or clear from its context, numerical values should be construed to include certain tolerances that those skilled in the art would recognize as having negligible importance, as such do not materially change the operability of the invention.

As used herein, the words “comprise,” “include,” contain,” and variants thereof are intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Having thus described the basic concept of the invention, it will be apparent to those skilled in the art that the foregoing detailed disclosure is intended to be presented by way of example only, and is not limiting. Various alterations, improvements, and modifications will occur to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be expressly stated in the claims.

I claim:

1. A light comprising:
a) a housing comprised of an elongated body having a forward end and a rearward end and defining a longitudinal axis;
b) a first bracket arm and a second bracket arm extending outwardly from the elongated body, wherein the first bracket arm is comprised of an inner wall opposed to an inner wall of the second bracket arm, the opposed inner walls of the first and second bracket arms defining a first open ended cavity capable of receiving a first mounting object; and
c) a light source contained in the forward end of the elongated body and operable to emanate light outwardly from the housing.

2. The light of claim 1, wherein the first bracket arm and the second bracket arm are flexible arms.

3. The light of claim 1, wherein the opposed inner walls of the first and second bracket arms are comprised of arcuate surfaces defining the first open ended cavity as a cylindrical cavity.

4. The light of claim 1, wherein the first bracket arm is comprised of a first elongated forward member extending substantially parallel to the longitudinal axis of the elongated body, and the second bracket arm is comprised of a second elongated forward member extending substantially parallel to the longitudinal axis of the elongated body.

5. The light of claim 1, wherein both of the first and second forward members include a recess, the recesses of the first and second forward members and the elongated body defining a second open ended cavity capable of receiving a second mounting object.

6. The light of claim 5, wherein the recesses of the first and second forward members are comprised of arcuate surfaces defining the second open ended cavity as a cylindrical cavity.

7. The light of claim 5, further comprising an elastic pad joined to the elongated body of the housing and contiguous with the second open ended cavity.

8. The light of claim 5, wherein the first bracket arm is further comprised of a first elongated rearward member including a first barb, and the second bracket arm is further comprised of a second elongated rearward member including a second barb, the first and second barbs and the elongated body defining a third open ended cavity capable of receiving a third mounting object.

9. The light of claim 1, wherein the first bracket arm is further comprised of a first elongated rearward member including a first barb, and the second bracket arm is further comprised of a second elongated rearward member including a second barb, the first and second barbs and the elongated body defining a second open ended cavity capable of receiving a second mounting object.

10. The light of claim 1, further comprising an elastic pad joined to the elongated body of the housing and extending longitudinally between the first and second bracket arms.

11. The light of claim 1, wherein the elongated body, the first bracket arm, and the second bracket arm are made of a single piece of material.

12. The light of claim 1, wherein the light is further comprised of a switch disposed in the rearward end of the elongated body of the housing, a membrane capable of actuating the switch, and a magnet disposed between the switch and the membrane.
